(19) United States
(12) Patent Application Publication
(10) Pub. No.: US 2012/0014119 A1
(43) Pub. Date: Jan. 19, 2012

(54) LAMP FASTENER OF BACKLIGHT MODULE

(76) Inventor: Gege Zhou, Shenzhen (CN)

(21) Appl. No.: 12/995,576

(22) PCT Filed: Nov. 11, 2010
(86) PCT No.: PCT/CN10/78656

§ 371 Date: Dec. 1, 2010

(30) Foreign Application Priority Data
Jul. 14, 2010 (CN) 201010230780.0

(51) Int. Cl. F21V 21/088

(52) U.S. Cl. 362/396

(57) ABSTRACT

The present invention provides a lamp fastener of a backlight module, and the lamp fastener has at least one closed clamping space defined by at least one set of a lower clamping space of a lower clamping portion and an upper clamping space of an upper clamping portion for stably clamping and positioning at least one backlight lamp. Thus, the present invention can surely prevent the backlight lamp from being separated from the lamp fastener, so that it is advantageous to enhance the installation reliability of the backlight lamp and the yield of impact test of the backlight lamp.

### FIELD OF THE INVENTION

The present invention relates to a lamp fastener of a backlight module, and more particularly to a lamp fastener capable of providing a closed clamping space for stably clamping and positioning backlight lamps and a backlight module having the lamp fastener.

### BACKGROUND OF THE INVENTION

Nowadays, for the convenience of installation and transportation, many components are generally installed into various modules in advance during the mass production of liquid crystal displays (LCDs). For example, a backlight module is constructed by backlight sources, a diffuser plate and etc., and then a LCD module is constructed by the backlight module, a LCD panel and a front frame.

Referring now to FIGS. 1 and 1A, an exploded perspective view of a traditional backlight module and a schematic view of a traditional backlight lamp fastener are illustrated, wherein a backlight module 10 substantially comprises a front frame 11, a LCD panel 12 and a backlight module 13. The front frame 11 is used to mount the LCD panel 12 on the backlight module 13. The backlight module 13 comprises a back plate 130, a reflector sheet 131, a plurality of backlight lamps 132, a plurality of sockets 133, a plurality of fasteners 134, a plurality of optical films 135 and a housing 136. The back plate 130 is used to support the reflector sheet 131. Electrode terminals or lead wires on two ends of the backlight lamps 132 is mounted on the back plate 130 through the sockets 133 disposed on at least one side of the reflector sheet 131. Meanwhile, the tubes of the backlight lamps 132 are mounted on the reflector sheet 131 through the fasteners 134. The optical films 135 are disposed above the backlight lamps 132, while the housing 136 is used to protect the foregoing elements of the backlight module 13.

Referring to FIG. 1A, the fasteners 134 generally comprises a support plate 134a, two anchor ends 134b, two pair of elastic arms 134c and an upper abutting end 134d. The two anchor ends 134b are extended downward from a lower surface of the support plate 134a, and the two anchor ends 134b are used to anchor and mount on installation holes (not-shown) of the reflector sheet 131. The two pair of the elastic arms 134c are extended upward from an upper surface of the support plate 134a, and each pair of the elastic arms 134c can form an open clamping space for elastically engaging and clamping the tubes of the backlight lamps 132. Furthermore, the upper abutting end 134d is used to abut against a lower surface of the optical films 135 to prevent the optical films 135 from being recessed downward.

However, there are some problems existing in the actual use of the fasteners 134, as follows: for installing the backlight lamp 132, an upward opening is formed between the two elastic arms 134c, so that the backlight lamp 132 can be inserted into the upward opening. But, when an impact test is executed after installation, the backlight lamp 132 easily jumps upward out of the open clamping space formed by the elastic arms 134c from the opening. Thus, the screen brightness of the backlight module 13 may malfunction due to the shift of the backlight lamp 132, resulting in affecting the yield of the impact test of the backlight module 13. To solve the foregoing problems, another solution is to design and narrow the opening width between the two elastic arms 134c in advance, so that it is uneasy for the backlight lamp 132 to jump out of the opening. However, the design of the narrow opening causes the engaging installation operation of the backlight lamp 132 becomes more difficult, and even to cause the breakage of the backlight lamp 132 due to assembly overexertion.

As a result, it is necessary to provide a lamp fastener of a backlight module to solve the problems existing in the conventional technologies, as described above.

### SUMMARY OF THE INVENTION

A primary object of the present invention is to provide a lamp fastener of a backlight module, wherein the lamp fastener has at least one closed clamping space defined by at least one set of a lower clamping space of a lower clamping portion and an upper clamping space of an upper clamping portion for stably clamping and positioning at least one backlight lamp, so as to surely prevent the backlight lamp from being separated from the lamp fastener. Thus, it is advantageous to enhance the installation reliability of the backlight lamp and the yield of impact test of the backlight lamp.

A secondary object of the present invention is to provide a lamp fastener of a backlight module, wherein the upper clamping portion of the lamp fastener can be directly integrally connected to the lower clamping portion through a flexible connection portion, so that it is advantageous to further simplify the installation operation and reduce the number of components.

To achieve the above object, the present invention provides a lamp fastener of a backlight module, wherein the lamp fastener comprises: a support plate; at least one lower clamping portion projected from an upper surface of the support plate, wherein each of the lower clamping portion has two lower connection ends and a lower clamping space; at least one upper clamping portion, each of which has two upper connection ends and an upper clamping space, wherein the upper connection ends are installed and connected to the lower connection ends, so that the lower clamping space and the upper clamping space commonly define a closed clamping space for clamping and positioning a backlight lamp; and at least one anchor end projected from a lower surface of the support plate.

In one embodiment of the present invention, the support plate, the lower clamping portion and the anchor end are integrated into a one-piece structure, and the upper clamping portion is separated from the one-piece structure.

Furthermore, the present invention provides another lamp fastener of a backlight module, wherein the lamp fastener comprises: a support plate; at least one lower clamping portion projected from an upper surface of the support plate, wherein each of the lower clamping portion has a lower connection end, a flexible connection portion and a lower clamping space; at least one upper clamping portion, each of which has an upper connection end and an upper clamping space, wherein the upper clamping portion is directly and integrally connected to the lower clamping portion through the flexible connection portion, while the upper connection end is installed and connected to the lower connection end, so that the lower clamping space and the upper clamping space commonly define a closed clamping space for clamping and positioning a backlight lamp; and at least one anchor end projected from a lower surface of the support plate.

In one embodiment of the present invention, the support plate, the lower clamping portion, the upper clamping portion and the anchor end are integrated into a one-piece structure.

In one embodiment of the present invention, the lower connection end comprises a lower engagement hook and a lower engagement groove, while the upper connection end comprises an upper engagement hook and an upper engagement groove, wherein the lower engagement hook is correspondingly engaged with the upper engagement groove, and the upper engagement hook is correspondingly engaged with the lower engagement groove.

In one embodiment of the present invention, the upper engagement hook further comprises an inclined surface for guiding the upper engagement hook to be engaged into the lower engagement groove.

In one embodiment of the present invention, each of the lower connection ends further comprises at least one lower block disposed on at least one side of the lower engagement hook and the lower engagement groove, while each of the upper connection ends further comprises at least one upper block disposed on at least one side of the upper engagement hook and the upper engagement groove, wherein the lower block is corresponding to the upper block.

In one embodiment of the present invention, the lower connection end comprises a lower insertion plate and a lower insertion groove, while the upper connection end comprises an upper insertion plate and an upper insertion groove, wherein the lower insertion plate is correspondingly inserted into the upper insertion groove, and the upper insertion plate is correspondingly inserted into the lower insertion groove.

In one embodiment of the present invention, the lamp fastener further comprises an upper abutting rod projected from the upper surface of the support plate, and an upper end of the upper abutting rod is curved to abut against an optical sheet of a backlight module.

In one embodiment of the present invention, the lamp fastener is made of transparent material.

In one embodiment of the present invention, the transparent material is transparent elastic buffering material.

### DESCRIPTION OF THE DRAWINGS

FIG. 1 is an exploded perspective view of a traditional backlight module;

FIG. 1A is a schematic view of a traditional backlight lamp fastener;

FIG. 2 is a partial installation view of a lamp fastener of a backlight module according to a first embodiment of the present invention;

FIG. 3 is a side view of the lamp fastener of FIG. 2;

FIG. 4 is an assembled perspective view of the lamp fastener according to the first embodiment of the present invention;

FIG. 4A is a perspective view of a lower clamping portion and an anchor end of the lamp fastener showed in a right half part of FIG. 4, wherein the profiles of the lower clamping portion and the anchor end are showed in view of an inclined front right lower angle of the right half part of FIG. 4;

FIG. 4B is a perspective view of an upper clamping portion of the lamp fastener showed in a right half part of FIG. 4, wherein the profiles of the upper clamping portion is showed in view of an inclined front left angle of the right half part of FIG. 4;

FIG. 5 is a side view of a lamp fastener according to a second embodiment of the present invention;

FIG. 5A is a partially enlarged view of an upper clamping portion and a lower clamping portion according to the second embodiment of the present invention;

FIG. 6 is a side view of a lamp fastener according to a third embodiment of the present invention;

FIG. 6A is a partially enlarged view of an upper clamping portion and a lower clamping portion according to the third embodiment of the present invention;

FIG. 7 is a side view of a lamp fastener according to a fourth embodiment of the present invention; and

FIG. 7A is a partially enlarged view of an upper clamping portion and a lower clamping portion according to the fourth embodiment of the present invention.

### DETAILED DESCRIPTION OF THE PREFERRED EMBODIMENTS

The structure and the technical means adopted by the present invention to achieve the above and other objects can be best understood by referring to the following detailed description of the preferred embodiments and the accompanying drawings. Furthermore, directional terms described by the present invention, such as upper, lower, front, back, left, right, inner, outer, side and etc., are only directions by referring to the accompanying drawings, and thus the used directional terms are used to describe and understand the present invention, but the present invention is not limited thereto.

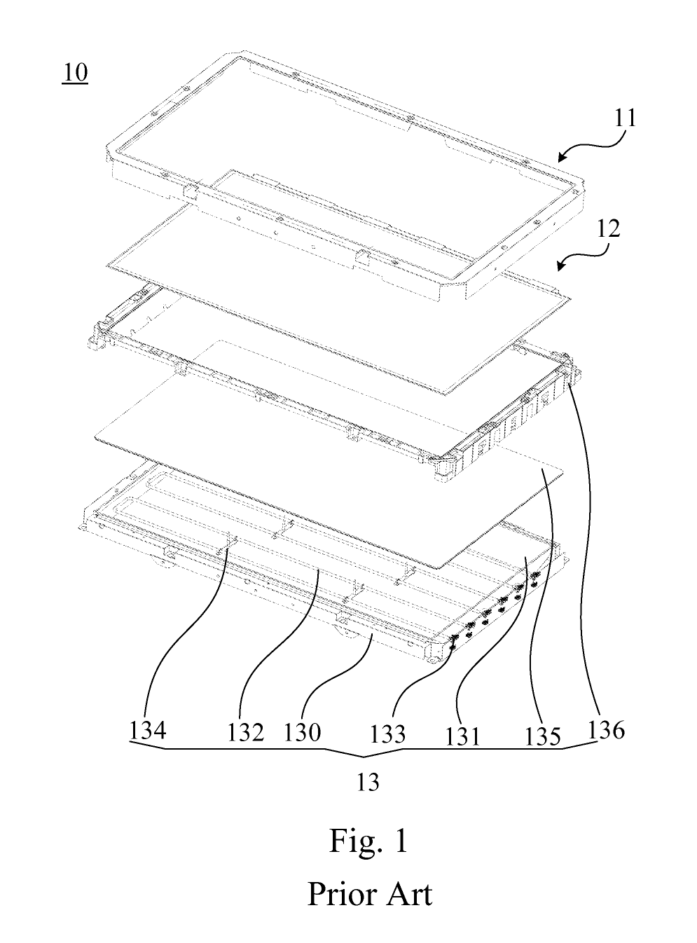

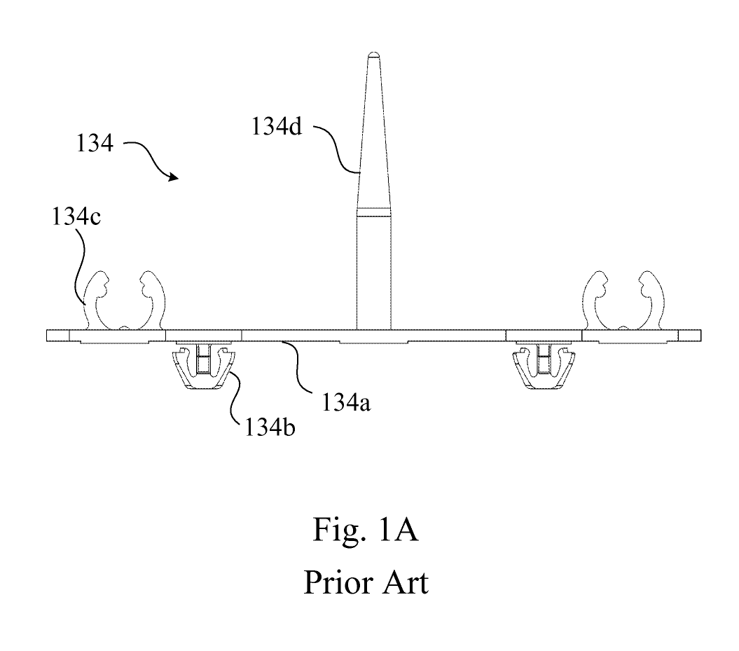

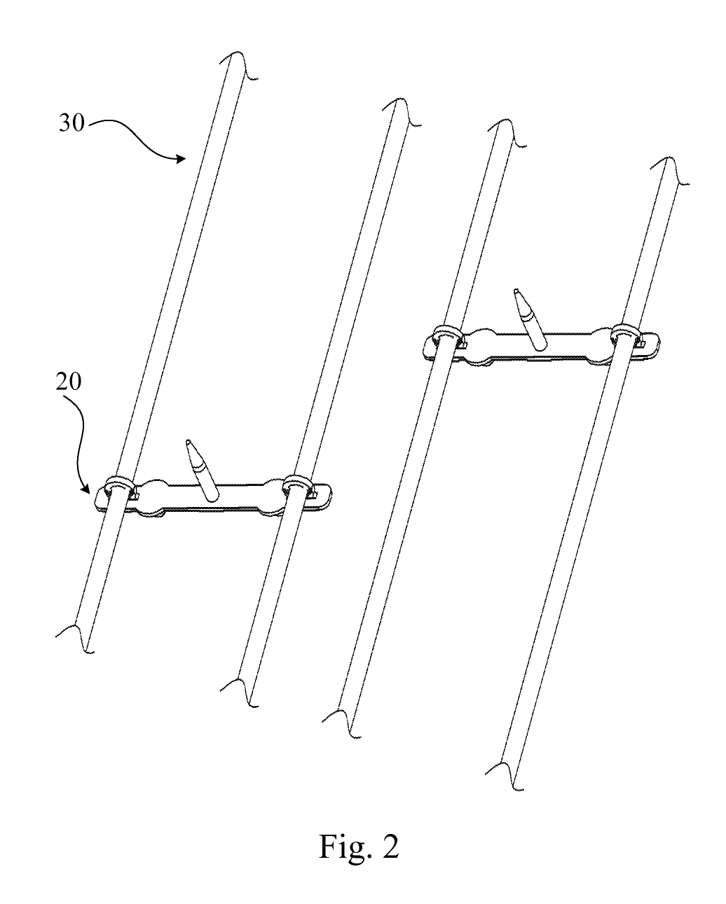

Referring now to FIG. 2, a partial installation view of a lamp fastener of a backlight module according to a first embodiment of the present invention is illustrated, wherein the lamp fastener 20 of the first embodiment of the present invention is mainly applied to the field of a backlight module of a liquid crystal displays (LCD), and the backlight module comprises a back plate, a reflector sheet, at least one backlight lamp 30, at least one lamp fastener 20, two support portions and at least two sockets. The present invention will describe detailed structures of the lamp fastener 20 hereinafter, and other components of the backlight module can be referred by FIG. 1. The lamp fastener 20 of the present invention can be applied to various types of backlight modules, so that the structures of other components of the backlight module are not limited thereto.

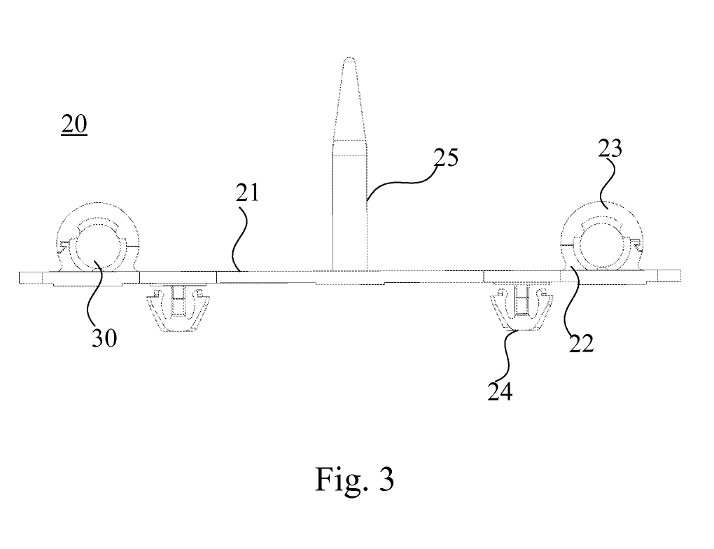

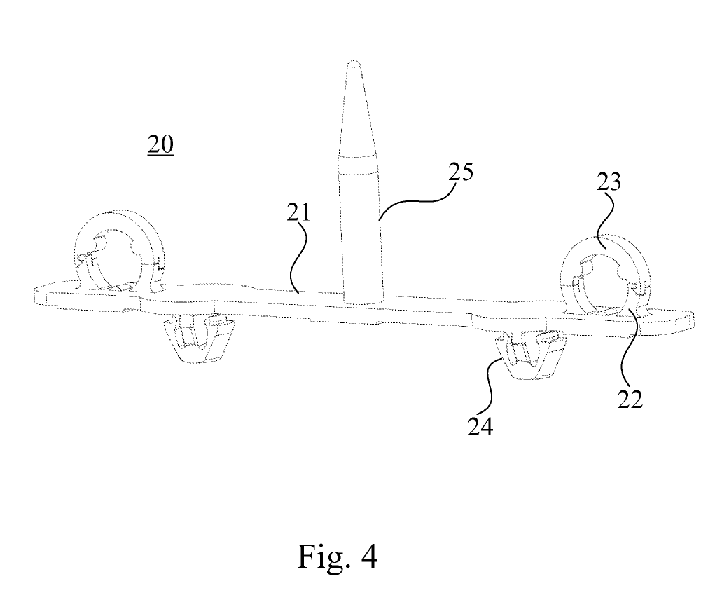

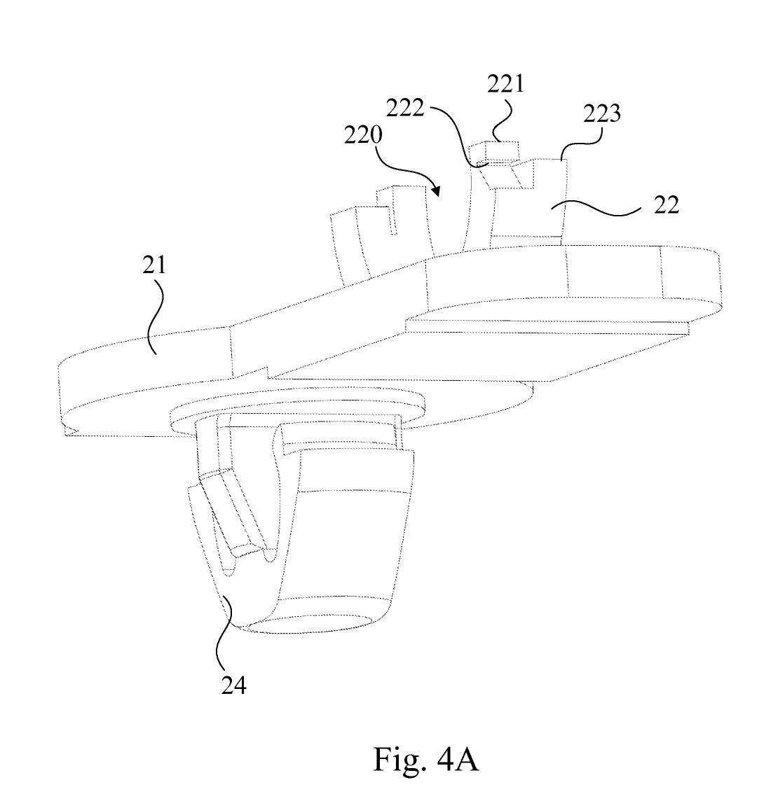

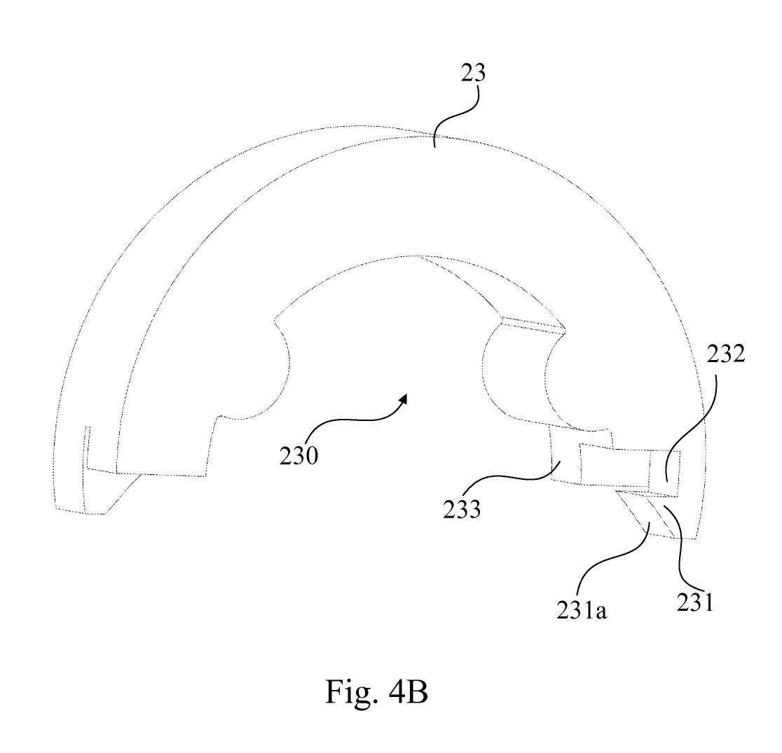

Referring now to FIGS. 3 and 4, the lamp fastener 20 in the first embodiment of the present invention comprises a support plate 21, at least one lower clamping portion 22, at least one upper clamping portion 23, at least one anchor end 24 and an upper abutting rod 25. In the embodiment, the number of the lower clamping portion 22, the upper clamping portion 23 and the anchor end 24 are two, respectively, but not limited thereto. The support plate 21, the lower clamping portion 22, the anchor end 24 and the upper abutting rod 25 are integrated into a one-piece structure, and the upper clamping portion 23 is separated from the one-piece structure. Preferably, the lamp fastener 20 is completely made of transparent material, and the transparent material is preferably transparent elastic buffering material. The support plate 21 is substantially an horizontal elongated strip plate. The lower clamping portion 22 is projected from an upper surface of the support plate 21. The upper clamping portion 23 is detachably installed and connected to the lower clamping portion 22, and the lower clamping portion 22 and the upper clamping portion 23 are used to commonly clamp and position the backlight lamp 30. In addition, the anchor end 24 is projected from a lower surface of the support plate 21.

Referring to FIG. 4A, a perspective view of a lower clamping portion and an anchor end of the lamp fastener showed in a right half part of FIG. 4 is illustrated, wherein FIG. 4A illustrates the profiles of the lower clamping portion 22 and the anchor end 24 are showed in view of an inclined front right lower angle of the right half part of FIG. 4, and wherein the lower clamping portion 22 of the first embodiment of the present invention is constructed by two curved projected arms, and each of the lower clamping portion 22 has two lower connection ends and a lower clamping space 220. In the embodiment, the lower connection end comprises a lower engagement hook 221, a lower engagement groove 222 and at least one lower block 223. The lower clamping space 220 is substantially a semi-circular space defined between the two curved projected arms. The lower engagement hook 221, the lower engagement groove 222 and the lower block 223 of the lower connection end are formed on two upper ends of each of the two curved projected arms. The lower engagement hook 221 is an upward hook structure, the lower engagement groove 222 is formed below the lower engagement hook 221, and the lower block 223 is disposed on at least one side of the lower engagement hook 221 and the lower engagement groove 222, such as disposed on a right side, a left side or both sides thereof. If each of the lower connection end is only provided with a single lower block 223, the lower blocks 223 of the two lower connection ends of the lower clamping portion 22 are preferably disposed on different sides, such as disposed on a left side and a right side, respectively. In addition, as shown in FIGS. 3 and 4, a suitable position on an inner periphery of the lower clamping space 220 can be further formed with at least one projection for supporting the backlight lamp 30 and reducing the contact area therebetween.

Referring to FIG. 4B, a perspective view of an upper clamping portion of the lamp fastener showed in a right half part of FIG. 4 is illustrated, wherein FIG. 4B illustrates the profiles of the upper clamping portion 23 is showed in view of an inclined front left angle of the right half part of FIG. 4, and wherein the upper clamping portion 23 of the first embodiment of the present invention is mainly a semi-circular or curved component. Each of the upper clamping portion 23 has two upper connection ends and an upper clamping space 230. In the embodiment, the upper connection end comprises an upper engagement hook 231, an upper engagement groove 232 and at least one upper block 233. The upper clamping space 230 is substantially a semi-circular space defined in the semi-circular or curved component. The upper engagement hook 231, the upper engagement groove 232 and the upper block 233 of the upper connection end are formed on two lower ends of the semi-circular or curved component. The upper engagement hook 231 is a downward hook structure, the upper engagement groove 232 is correspondingly formed above the upper engagement hook 231, and the upper engagement hook 231 preferably further comprises an inclined surface 231a, so that the upper engagement hook 231 can be smoothly engaged into the lower engagement groove 222. The upper block 233 is disposed on at least one side of the upper engagement hook 231 and the upper engagement groove 232, such as disposed on a right side, a left side or both sides thereof. If each of the upper connection end is only provided with a single upper block 233, the upper blocks 233 of the two upper connection ends of the upper clamping portion 23 are preferably disposed on different sides, such as disposed on a left side and a right side, respectively. In addition, a suitable position on an inner periphery of the upper clamping space 230 can be further formed with at least one projection for supporting the backlight lamp 30 and reducing the contact area therebetween.

Referring to FIGS. 2, 3 and 4, the anchor ends 24 according to the first embodiment of the present invention are projected from a lower surface of the support plate 21, the two anchor ends 24 are used to anchor and mount on installation holes of a reflector sheet of the backlight module, wherein the installation thereof can be referring to FIG. 1. Furthermore, the upper abutting rod 25 is projected from the upper surface of the support plate 21, and an upper end of the upper abutting rod 25 is curved to abut against an optical sheet of a backlight module, such as a diffuser plate, wherein the installation thereof also can be referring to FIG. 1.

Referring to FIGS. 2 to 4B, when the lamp fastener 20 of the first embodiment of the present invention is used to clamp and position the backlight lamp 30, the backlight lamp 30 is firstly placed in the lower clamping space 220 of the lower clamping portion 22, and then the upper clamping portion 23 is installed on the lower clamping portion 22. In this case, the upper engagement hooks 231 of the upper connection ends are engaged into the lower engagement groove 222 of the lower connection end, while the lower engagement hooks 221 of the lower connection ends are engaged into the upper engagement groove 232 of the upper connection end. After installation, the lower blocks 223 prevent the upper engagement hooks 231 from being horizontally slid and separated from the lower engagement groove 222, while the upper blocks 233 prevent the lower engagement hooks 221 from being horizontally slid and separated from the upper engagement groove 232. Moreover, the lower clamping space 220 and the upper clamping space 230 can commonly define a closed clamping space for clamping and positioning the backlight lamp 30. Then, the anchor ends 24 are used to anchor and mount the lamp fastener 20 on installation holes of the reflector sheet of the backlight module, so that the supporting and positioning operation of the backlight lamp 30 can be finished.

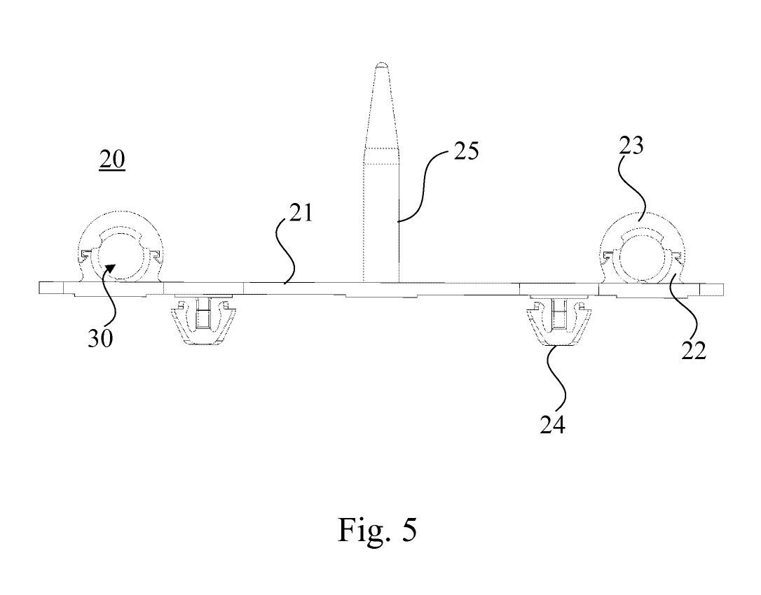

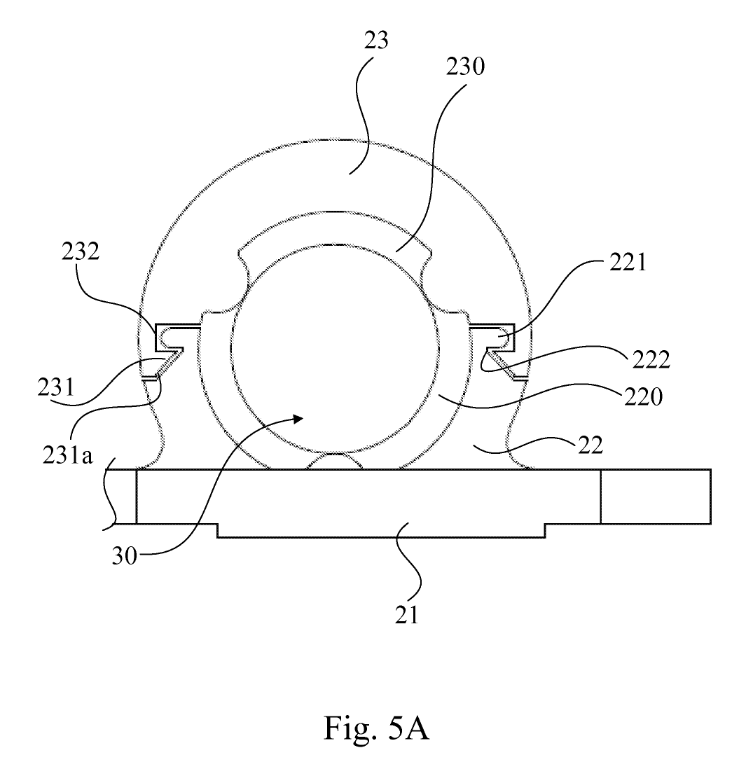

Referring now to FIGS. 5 and 5A, a lamp fastener of backlight module according to a second embodiment of the present invention is similar to the first embodiment of the present invention, so as to use identical component terms and numerals, but the difference of the second embodiment is that: the lower connection end of the lower clamping portion 22 according to the lamp fastener 20 of backlight module of the second embodiment only comprises: the lower engagement hooks 221 and the lower engagement grooves 222, but the lower blocks 223 are omitted, wherein the engagement and installation of the lower connection ends and the upper connection ends are the same as the first embodiment, but also can be installed by a horizontal sliding insertion manner. In other words, the upper engagement hooks 231 can be horizontally slid and inserted into the lower engagement groove 222, while the lower engagement hooks 221 can be horizontally slid and inserted into the upper engagement groove 232. After installation, a small amount of transparent adhesive can be dropped thereto, so as to ensure the installation reliability between the lower clamping portion 22 and the upper clamping portion 23. Furthermore, in the embodiment, the lower engagement hooks 221 of the lower connection end of the lower clamping portion 22 preferably further has a curved surface design. During the upper engagement hooks 231 of the upper connection end of the upper clamping portion 23 passes through the lower engagement hooks 221 to be engaged into the lower engagement groove 222 from top to bottom, the curved surface design of the lower engagement hooks 221 is advantageous for the upper engagement hooks 231 to smoothly pass through the lower engagement hooks 221 and be engaged into the lower engagement groove 222.

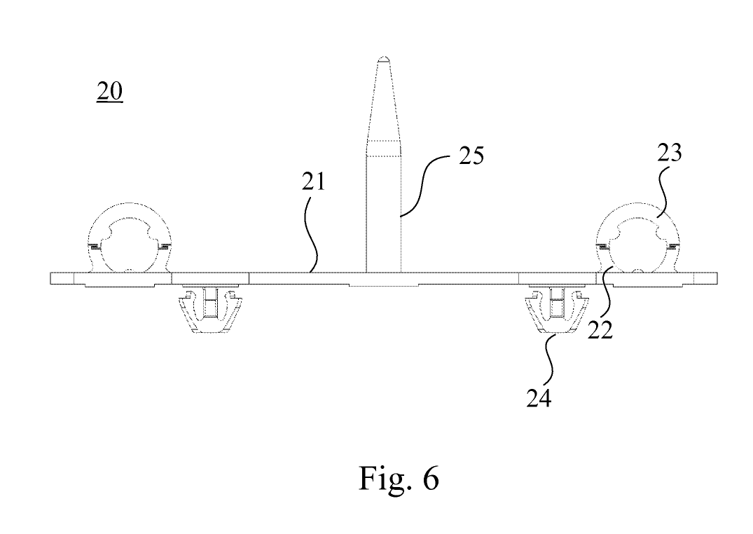

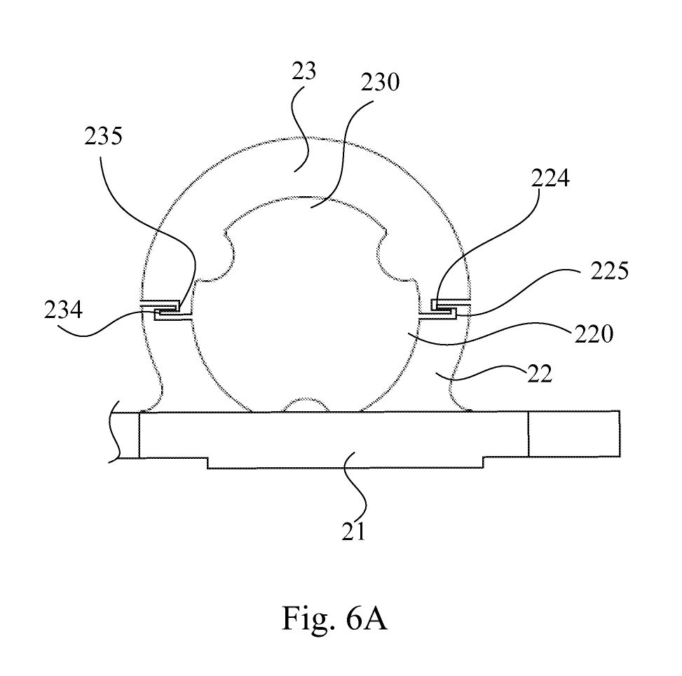

Referring now to FIGS. 6 and 6A, a lamp fastener of backlight module according to a third embodiment of the present invention is similar to the first and second embodiments of the present invention, so as to use identical component terms and numerals, but the difference of the third embodiment is that: the lower connection end of the lower clamping portion 22 according to the lamp fastener 20 of backlight module of the third embodiment comprises a lower insertion plate 224 and a lower insertion groove 225 for replacing the lower engagement hooks 221 and the lower engagement groove 222, while the lower blocks 223 are omitted. Meanwhile, the upper connection end of the upper clamping portion 23 comprises an upper insertion plate 234 and an upper insertion groove 235 for replacing the upper engagement hooks 231 and the upper engagement groove 232, while the upper blocks 233 are omitted. The installation of the lower connection end and the upper connection end is identical to the horizontal sliding insertion manner of the second embodiment. In other words, the upper insertion plate 234 can be horizontally slid and inserted into the lower insertion groove 225, while the lower insertion plate 224 can be horizontally slid and inserted into the upper insertion groove 235. After installation, a small amount of transparent adhesive can be dropped thereto, so as to ensure the installation reliability between the lower clamping portion 22 and the upper clamping portion 23.

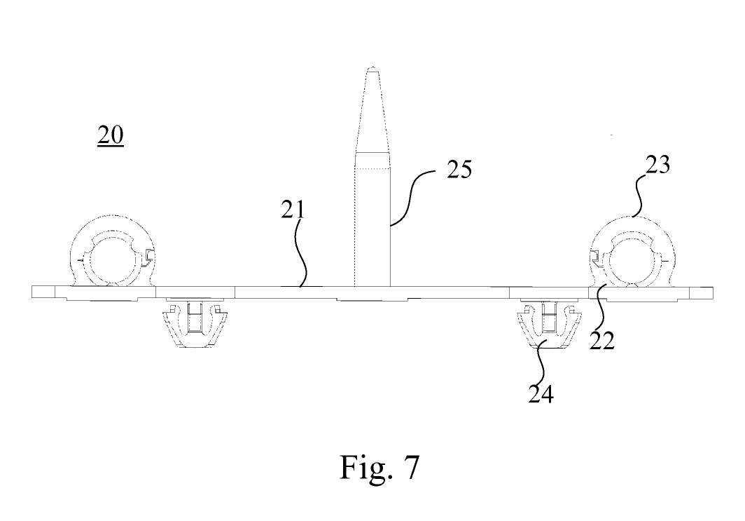

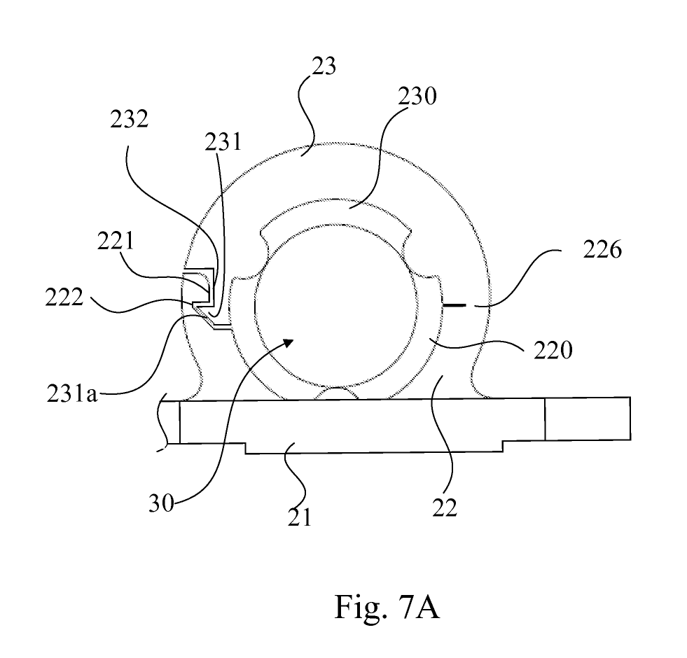

Referring now to FIGS. 7 and 7A, a lamp fastener of backlight module according to a fourth embodiment of the present invention is similar to the first embodiment of the present invention, so as to use identical component terms and numerals, but the difference of the fourth embodiment is that: each of the lower connection end of the lower clamping portion 22 according to the lamp fastener 20 of backlight module of the fourth embodiment comprises a lower connection end, a flexible connection portion 226 and a lower clamping space 220, while each of the upper clamping portion 23 comprises an upper connection end and an upper clamping space 230. The flexible connection portion 226 has a flexibility, wherein the flexibility is contributed from the material property of the transparent elastic buffering material itself. A lower end of the upper clamping portion 23 is directly and integrally connected to an upper end of the lower clamping portion 22 through the flexible connection portion 226, so that the flexible connection portion 226 can be used as a pivotal point. Thus, the upper clamping portion 23 can be pivotally rotated in relation to the flexible connection portion 226 to carry out an open or close operation, so that the upper connection end of the other lower end of the upper clamping portion 23 can be separated from the lower connection end of the other upper end of the lower clamping portion 22 (or the upper connection end can be installed and connected to the lower connection end). After the upper connection end is installed and connected to the lower connection end, the lower clamping space 220 and the upper clamping space 230 can commonly define a closed clamping space for clamping and positioning the backlight lamp 30. Because the upper clamping portion 23 can be directly and integrally connected to the lower clamping portion 22 through the flexible connection portion 226, it is advantageous to further simplify the installation operation and reduce the number of components. Furthermore, in the embodiment, the lower engagement hooks 221 of the lower connection end of the lower clamping portion 22 preferably further has a curved surface design. During the upper engagement hooks 231 of the upper connection end of the upper clamping portion 23 passes through the lower engagement hooks 221 to be engaged into the lower engagement groove 222 from top to bottom, the curved surface design of the lower engagement hooks 221 is advantageous for the upper engagement hooks 231 to smoothly pass through the lower engagement hooks 221 and be engaged into the lower engagement groove 222.

As described above, in comparison with the traditional lamp fastener of backlight module which has an upward opening formed between the two elastic arms to cause disadvantages including the jumping risk of the backlight lamp in a certain degree and the installation inconvenience, the lamp fastener 20 of the present invention as shown in FIGS. 2 to 7 is provided with at least one closed clamping space defined by at least one set of the lower clamping space 220 of the lower clamping portion 22 and the upper clamping space 230 of the upper clamping portion 23 for stably clamping and positioning at least one backlight lamp 30, so as to surely prevent the backlight lamp 30 from being separated from the lamp fastener 20. Thus, it is advantageous to enhance the installation reliability of the backlight lamp 30 and the yield of impact test of the backlight lamp 30. In addition, as shown in FIGS. 7 and 7A, the upper clamping portion 23 of the lamp fastener 20 can be directly integrally connected to the lower clamping portion 22 through the flexible connection portion 226, so that it is advantageous to further simplify the installation operation and reduce the number of components.

The present invention has been described with a preferred embodiment thereof and it is understood that many changes and modifications to the described embodiment can be carried out without departing from the scope and the spirit of the invention that is intended to be limited only by the appended claims.

1. A lamp fastener of a backlight module, characterized in that: the lamp fastener comprises:
a support plate;
at least one lower clamping portion projected from an upper surface of the support plate, wherein each of the lower clamping portion has two lower connection ends and a lower clamping space;
at least one upper clamping portion, each of which has two upper connection ends and an upper clamping space, wherein the upper connection ends are installed and connected to the lower connection ends, so that the lower clamping space and the upper clamping space commonly define a closed clamping space for clamping and positioning a backlight lamp; and
at least one anchor end projected from a lower surface of the support plate;
wherein the support plate, the lower clamping portion and the anchor end are integrated into a one-piece structure, and the upper clamping portion is separated from the one-piece structure; and
wherein the lower connection end comprises a lower engagement hook and a lower engagement groove, while the upper connection end comprises an upper engagement hook and an upper engagement groove, wherein the lower engagement hook is correspondingly engaged with the upper engagement groove, and the upper engagement hook is correspondingly engaged with the lower engagement groove.

2. A lamp fastener of a backlight module, characterized in that: the lamp fastener comprises:
a support plate;
at least one lower clamping portion projected from an upper surface of the support plate, wherein each of the lower clamping portion has two lower connection ends and a lower clamping space;
at least one upper clamping portion, each of which has two upper connection ends and an upper clamping space, wherein the upper connection ends are installed and connected to the lower connection ends, so that the lower clamping space and the upper clamping space commonly define a closed clamping space for clamping and positioning a backlight lamp; and
at least one anchor end projected from a lower surface of the support plate.

3. The lamp fastener of a backlight module according to claim 2, characterized in that: the support plate, the lower clamping portion and the anchor end are integrated into a one-piece structure, and the upper clamping portion is separated from the one-piece structure.

4. The lamp fastener of a backlight module according to claim 2, characterized in that: the lower connection end comprises a lower engagement hook and a lower engagement groove, while the upper connection end comprises an upper engagement hook and an upper engagement groove, wherein the lower engagement hook is correspondingly engaged with the upper engagement groove, and the upper engagement hook is correspondingly engaged with the lower engagement groove.

5. The lamp fastener of a backlight module according to claim 4, characterized in that: the upper engagement hook further comprises an inclined surface for guiding the upper engagement hook to be engaged into the lower engagement groove.

6. The lamp fastener of a backlight module according to claim 4, characterized in that: each of the lower connection ends further comprises at least one lower block disposed on at least one side of the lower engagement hook and the lower engagement groove, while each of the upper connection ends further comprises at least one upper block disposed on at least one side of the upper engagement hook and the upper engagement groove, wherein the lower block is corresponding to the upper block.

7. The lamp fastener of a backlight module according to claim 2, characterized in that: the lower connection end comprises a lower insertion plate and a lower insertion groove, while the upper connection end comprises an upper insertion plate and an upper insertion groove, wherein the lower insertion plate is correspondingly inserted into the upper insertion groove, and the upper insertion plate is correspondingly inserted into the lower insertion groove.

8. The lamp fastener of a backlight module according to claim 2, characterized in that: the lamp fastener further comprises an upper abutting rod projected from the upper surface of the support plate, and an upper end of the upper abutting rod is curved to abut against an optical sheet of a backlight module.

9. A lamp fastener of a backlight module, characterized in that: the lamp fastener comprises:
a support plate;
at least one lower clamping portion projected from an upper surface of the support plate, wherein each of the lower clamping portion has a lower connection end, a flexible connection portion and a lower clamping space;
at least one upper clamping portion, each of which has an upper connection end and an upper clamping space, wherein the upper clamping portion is directly and integrally connected to the lower clamping portion through the flexible connection portion, while the upper connection end is installed and connected to the lower connection end, so that the lower clamping space and the upper clamping space commonly define a closed clamping space for clamping and positioning a backlight lamp; and
at least one anchor end projected from a lower surface of the support plate.

10. The lamp fastener of a backlight module according to claim 9, characterized in that: the support plate, the lower clamping portion, the upper clamping portion and the anchor end are integrated into a one-piece structure.

11. The lamp fastener of a backlight module according to claim 9, characterized in that: the lower connection end comprises a lower engagement hook and a lower engagement groove, while the upper connection end comprises an upper engagement hook and an upper engagement groove, wherein the lower engagement hook is correspondingly engaged with the upper engagement groove, and the upper engagement hook is correspondingly engaged with the lower engagement groove.

12. The lamp fastener of a backlight module according to claim 11, characterized in that: the upper engagement hook further comprises an inclined surface for guiding the upper engagement hook to be engaged into the lower engagement groove.

13. The lamp fastener of a backlight module according to claim 11, characterized in that: each of the lower connection ends further comprises at least one lower block disposed on at least one side of the lower engagement hook and the lower engagement groove, while each of the upper connection ends further comprises at least one upper block disposed on at least one side of the upper engagement hook and the upper engagement groove, wherein the lower block is corresponding to the upper block.

14. The lamp fastener of a backlight module according to claim 9, characterized in that: the lamp fastener further comprises an upper abutting rod projected from the upper surface of the support plate, and an upper end of the upper abutting rod is curved to abut against an optical sheet of a backlight module.
